(19) United States
(12) Patent Application Publication
(10) Pub. No.: US 2008/0279173 A1
(43) Pub. Date: Nov. 13, 2008

(54) Method to Synchronize Receiver's Clock to Transmitter's Clock at Sub-100Nsec

(75) Inventors: Zhenyu Zhang, San Jose, CA (US); Yifeng Zhang, San Jose, CA (US)

Correspondence Address: NXP, B.V.;NXP INTELLECTUAL PROPERTY DEPARTMENT, M/S41-SJ, 1109 MCKAY DRIVE, SAN JOSE, CA, 95131, US

(73) Assignee: NXP B.V., Eindhoven (NL)

(21) Appl. No.: 11/814,073

(22) PCT Filed: Jan. 13, 2006
(86) PCT No.: PCT/IB2006/050136

§ 371 Date: Jun. 27, 2008

Related U.S. Application Data
(60) Provisional application No. 60/644,078, filed on Jan. 14, 2005.
(60) Provisional application No. 60/676,363, filed on Apr. 28, 2005.

(51) Int. Cl. H04J 3/06

(52) U.S. Cl. 370/350

(57) ABSTRACT

A sender (702) transmits one or more frames to a receiver (704). The receiver (704) either calculates a carrier frequency difference or a time difference using the one or more frames. A clock (722) in the receiver (704) is synchronized with a clock (714) in the sender (702) using the carrier frequency difference or the time difference.

In a wireless system a transmitting device typically sends a packet or frame to an intended receiving device that provides the receiver with the time in which a subsequent frame will be sent. The time defined in the frame is based on the local clock of the transmitter. The receiver then synchronizes its local clock to that of the transmitter's clock. Synchronization allows the receiver to turn on its CCA module at the proper time and receive the correct frame.

One example of the scheduling of data receipt or transmission is disclosed in the wireless Universal Serial Bus (USB) draft specification. The specification allows a host to send a micro-management control (MMC) frame to a device. The MMC frame schedules a time with the device whereby the host will receive from or transmit data to the device.

The MBOA (MultiBand OFDM Alliance) Wireless Medium Access Control (MAC) specification defines another form of clock synchronization for devices operating on the same channel. All devices send a beacon frame at a specified time. The beacons will not transmit at the same time when one or more device clocks have drifted away from the common time. All devices then synchronize to the device whose beacon is sent last, which corrects or compensates for the clock drift.

The accuracy of the WUSB and MBOA clock synchronization techniques are in the order of one microsecond or more. In some systems, however, this level of accuracy is not sufficient. For example, in time frequency interleaving (TFI) systems, a receiver operates in a particular TFI channel while other devices operate in other TFI channels. The frames from the other TFI channels can interfere with the frames transmitting over the particular TFI channel, resulting in simultaneous operating piconet (SOP) interferences. SOP interferences can result in clear channel assessment (CCA) detection failures.

FIG. 1 is a diagrammatic illustration of two frames transmitting over a TFI channel in accordance with the prior art. A transmitter sends a frame (not shown) to a receiver indicating frame 100 will be sent at time t₁. When the receiver's clock is not effectively synchronized to the sender's clock, the receiver can turn on too early (i.e., time t₀). This allows the receiver to mistakenly receive frame 102 instead of expected frame 100. The receiver can therefore fail to detect frame 100 because the receiver cannot reset in time to receive frame 100. Moreover, having a receiver turn on earlier than necessary causes the receiver to consume more power than when a receiver's clock is more effectively synchronized to the sender's clock.

In accordance with the invention, methods for synchronizing a receiver's clock to a sender's clock in a wireless system are provided. A sender transmits one or more frames to a receiver. The receiver either calculates a carrier frequency difference or a time difference using the one or more frames. A clock in the receiver is synchronized with a clock in the sender using the carrier frequency difference or the time difference.

The invention will best be understood by reference to the following detailed description of embodiments in accordance with the invention when read in conjunction with the accompanying drawings, wherein:

FIG. 1 is a diagrammatic illustration of two frames transmitting over a TFI channel in accordance with the prior art;

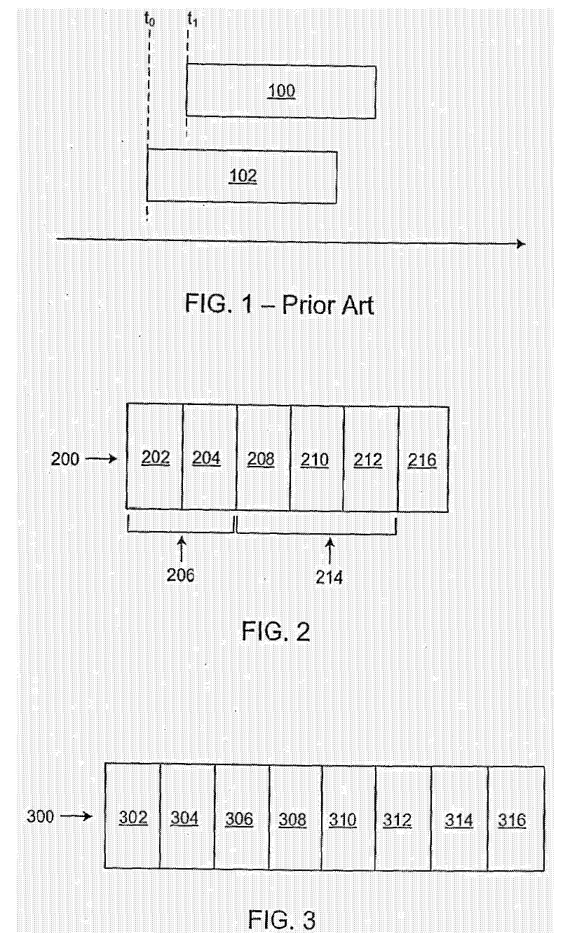

FIG. 2 is a diagrammatic illustration of a first frame format in an embodiment in accordance with the invention;

FIG. 3 is a diagrammatic illustration of a second frame format in an embodiment in accordance with the invention;

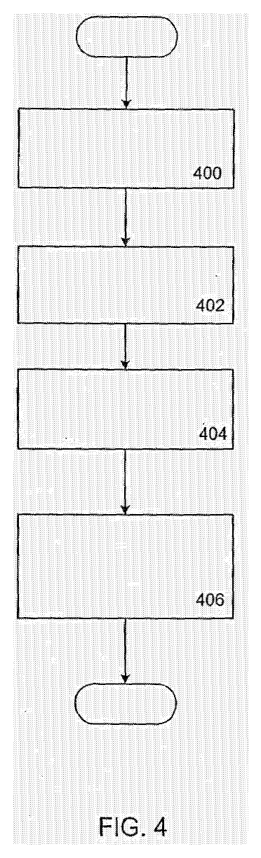

FIG. 4 is a flowchart of a first method for synchronizing a clock in a receiver to a clock in a sender using the frame shown in FIG. 2 or the frame shown in FIG. 3;

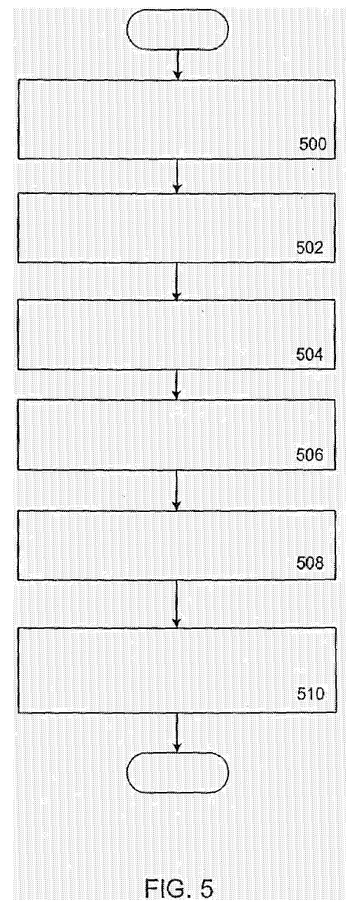

FIG. 5 is a flowchart of a second method for synchronizing a clock in a receiver to a clock in a sender in an embodiment in accordance with the invention;

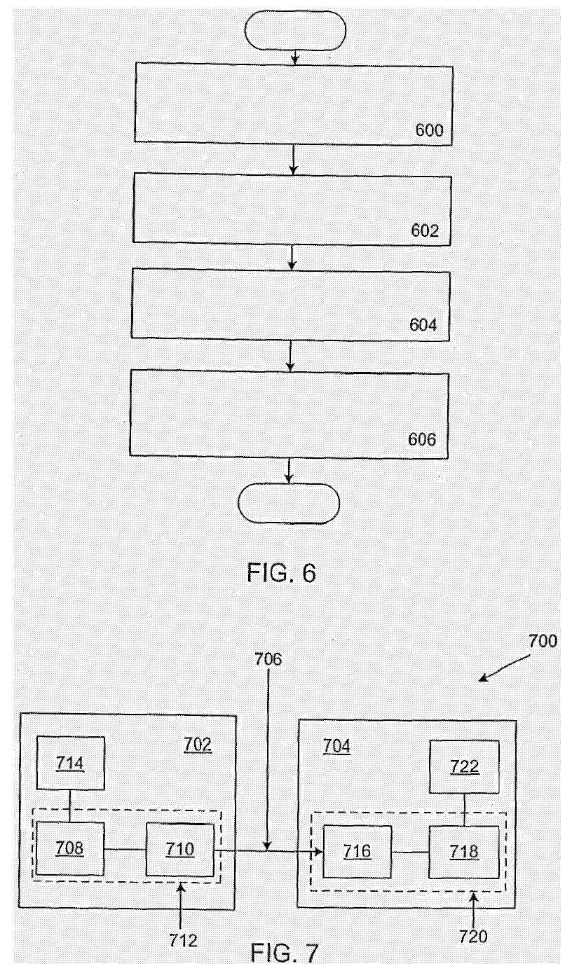

FIG. 6 is a flowchart of a third method for synchronizing a clock in a receiver to a clock in a sender in an embodiment in accordance with the invention; and

FIG. 7 is a block diagram illustrating a wireless system in an embodiment in accordance with the invention.

The following description is presented to enable one skilled in the art to make and use embodiments in accordance with the invention. Various modifications to the disclosed embodiments will be readily apparent to those skilled in the art, and the generic principles herein may be applied to other embodiments. Thus, the invention is not intended to be limited to the embodiments shown, but is to be accorded the widest scope consistent with the appended claims and with the principles and features described herein.

With reference to the figures and in particular with reference to FIG. 2, there is shown a diagrammatic illustration of a first frame format according to an embodiment in accordance with the invention. Frame 200 includes six fields and is configured as a MAC PHY frame in an embodiment in accordance with the invention. Field 202 is configured as a preamble field, which is used for a variety of functions. For example, a network or device may use the preamble field to detect the presence of a signal.

Field 204 is configured as a Start of Frame Delimiter (SFD) field. SFD indicates the start of frame 200. Fields 202, 204 form a PLCP (Physical Layer Convergence Protocol) preamble 206 in an embodiment in accordance with the invention.

Fields 208, 210, 212 form a PLCP header 214 in an embodiment in accordance with the invention. Field 208 is configured as a length field that indicates the length of the payload in bytes. Field 210 is a signaling field that indicates the rate or speed of the signal. Field 212 is configured as a frame check sequence that is used for error checking. Typically frame check sequence 212 includes a cyclical redundancy check (CRC). And finally, field 216 is configured as a payload or client data field.

FIG. 3 is a diagrammatic illustration of a second frame format in an embodiment in accordance with the invention. Frame 300 includes eight fields and is configured as an MBOA MAC PHY frame in an embodiment in accordance with the invention. Field 302 is configured as a preamble field, which is used by a network or device to detect the presence of a signal and to be ready to receive the data included in frame 300.

Field 304 is configured as a start frame delimiter that indicates the start of frame 300. Fields 306, 308 are a destination address field and a source address field, respectively. The destination address field is used to identify the device or devices that receive frame 300. The source address field identifies the device that transmitted or sent frame 300.

Field 310 is configured as a length field that indicates the length in bytes of the data field 312. Field 314 is a frame check sequence that is used for error checking. Typically frame check sequence 314 includes a cyclical redundancy check (CRC).

Field 316 is a pad field that typically includes extra data bits that are added in order to bring the frame length up to a particular length. For example, under 802.3z standard, a MAC frame has a minimum length of 512 bytes. The extra data bits are used to provide carrier frequency difference information in an embodiment in accordance with the invention. Pursuant to the MBOA MAC-PHY interface specification 0v941, the PHY clock accuracy is represented by eight bits located at address 38(h) in static parameter coding. The clock accuracy is passed to the receiver's MAC controller as parameter “PHYClockAccuracy.”

Referring to FIG. 4, there is shown a flowchart of a first method for synchronizing a clock in a receiver to a clock in a sender using the frame shown in FIG. 2 or the frame shown in FIG. 3. Initially a frame is received from a sender, as shown in block 400. The receiver then reviews the frame at block 404. If the frame is a MAC PHY frame (see FIG. 2), the receiver's PHY layer reviews the PLCP preamble and PLCP header and calculates a carrier frequency difference at block 306. If the frame is an MBOA MAC PHY frame (see FIG. 3), the MAC controller obtains the clock accuracy information from field 316 and calculates a carrier frequency difference at block 306. The receiver then synchronizes its clock to the sender's clock using the calculated carrier frequency difference (block 308).

FIG. 5 is a flowchart of a second method for synchronizing a clock in a receiver to a clock in a sender in an embodiment in accordance with the invention. Initially a frame is received from a sender, as shown in block 500. A timestamp is then associated to the frame (block 502). The timestamp indicates the time of the receiver's clock when the frame was received. The MAC controller timestamps each frame that is received from the PHY layer in an embodiment in accordance with the invention. The MAC controller appends the timestamp to the frame in one embodiment in accordance with the invention. In another embodiment in accordance with the invention, the MAC controller stores each timestamp in a queue.

A subsequent frame is then received by the receiver, as shown in block 504. A timestamp is then associated to the subsequent frame (block 506). The timestamp indicates the time of the receiver's clock when the frame was received. The receiver then calculates a time difference using the two timestamps (block 508). The difference includes a guard time, the propagation time, and the clock synchronization differences in an embodiment in accordance with the invention. Using the calculated time difference the receiver synchronizes its clock to the sender's clock (block 510).

Referring to FIG. 6, there is shown a flowchart of a third method for synchronizing a clock in a receiver to a clock in a sender in an embodiment in accordance with the invention. Initially a frame is received from a sender, as shown in block 600. The receiver then receives a subsequent frame from the sender at block 602. The receiver calculates a time difference based on when it received the two frames with respect to its local clock time. The time difference includes a guard time, the propagation time, and the clock synchronization differences in an embodiment in accordance with the invention. Using the calculated time difference the receiver synchronizes its clock to the sender's clock (block 606).

For example, a sender transmits a MMC frame at block 600 in an embodiment in accordance with the invention. The MMC frame indicates to the receiver when a frame of USB data will be sent. The frame of USB data is the second frame received by the receiver at block 602. Based on the time difference between the time the receiver received the second frame and the time the receiver received the first frame, the receiver calculates the time difference.

In another embodiment in accordance with the invention, a sender transmits a MMC frame at block 600 in an embodiment in accordance with the invention. The MMC frame indicates to the receiver when a subsequent MMC frame will be sent. The subsequent MMC frame is the second frame received by the receiver at block 602. Based on the time difference between the time the receiver received the second frame and the time the receiver received the first frame, the receiver calculates the time difference.

FIG. 7 is a block diagram illustrating a wireless system in an embodiment in accordance with the invention. System 700 includes sender 702 and receiver 704. Sender 702 transmits one or more frames to receiver 704 via wireless communication link 706. The frame or frames are constructed by MAC layer 708 and PHY layer 710. MAC layer 708 and PHY layer 710 are included in MAC controller 712 in an embodiment in accordance with the invention.

The one or more frames include information regarding a time defined by local clock 714 in an embodiment in accordance with the invention. For example, in one embodiment in accordance with the invention the one or more frames are configured as MAC PHY frames. In other embodiments in accordance with the invention, the one or more frames are configured as MBOA MAC PHY frames or MMC frames.

PHY layer 716 in receiver 704 receives the frame or frames and MAC layer 718 determines a time difference or a carrier frequency difference using an embodiment shown in FIG. 4, FIG. 5, or FIG. 6. MAC layer 718 and PHY layer 716 are included in MAC controller 720 in an embodiment in accordance with the invention. Using the calculated time or carrier frequency difference, MAC controller 720 adjusts the time of local clock 722 to synchronize clock 720 with local clock 712.

1. A method for synchronizing a clock in a receiving device to a clock in a sending device in a wireless network, comprising: receiving a first frame; determining a first time representing when the first frame is received by the receiving device; receiving a second frame; determining a second time representing when the second frame is received by the receiving device; calculating a time difference using the first and second times; and synchronizing the clock in the receiving device to the clock in the sending device using the time difference.

2. The method of claim 1, wherein receiving a first frame comprises receiving a first MMC frame.

3. The method of claim 2, wherein receiving a second frame comprises receiving a second MMC frame.

4. The method of claim 2, wherein receiving a second frame comprises receiving a USB data frame.

5. The method of claim 1, wherein determining a first time indicating when the second frame is received by the receiving device comprises appending a first timestamp to the first frame.

6. The method of claim 5, wherein determining a second time indicating when the second frame is received by the receiving device comprises appending a second timestamp to the second frame.

7. The method of claim 6, wherein calculating a time difference using the first and second times comprises calculating a time difference using the first and second timestamps.

8. A method for synchronizing a clock in a receiving device to a clock in a sending device in a wireless network, comprising: receiving a frame comprised of a preamble and a header; calculating a carrier frequency difference using the preamble and the header; and synchronizing the clock in the receiving device to the clock in the sending device using the carrier frequency difference.

9. The method of claim 8, wherein calculating a carrier frequency difference using the preamble and the header comprises calculating a carrier frequency difference using a PLCP preamble and a PLCP header.

10. The method of claim 8, wherein calculating a carrier frequency difference using the preamble and the header comprises obtaining a carrier frequency difference from one or more bits in a pad field in the frame.

11. A receiving device, comprising: a clock; and a controller operable to calculate a time difference between a first time representing when a first frame is received and a second time representing when a second frame is received and operable to adjust the clock using the calculated time difference.

12. The receiving device of claim 11, wherein the first frame comprises a first MMC frame.

13. The receiving device of claim 12, wherein the second frame comprises a second MMC frame.

14. The receiving device of claim 12, wherein the second frame comprises a USB data frame.

15. The receiving device of claim 11, wherein the controller is operable to append a first timestamp to the first frame and a second timestamp to the second frame, and wherein the controller is operable to calculate a time difference using the first and second timestamps.

16. A receiving device comprising: a clock; and a controller operable to determine a carrier frequency difference using a received frame and operable to adjust the clock using the calculated carrier frequency difference.

17. The receiving device of claim 16, wherein the received frame comprises a preamble and a header and wherein the controller is operable to determine the carrier frequency difference using the preamble and the header.

18. The receiving device of claim 17, wherein the frame comprises a MAC PHY frame and the preamble and header comprise a PLCP preamble and a PLCP header.

19. The receiving device of claim 16, wherein the frame comprises a MBOA MAC PHY frame and wherein the controller is operable to determine the carrier frequency difference from one or more data bits in a pad field in the MBOA MAC PHY frame.
